(19) United States
(12) Patent Application Publication
(10) Pub. No.: US 2026/0333547 A1
(43) Pub. Date: Oct. 22, 2026

(54) CONTROL UNIT FOR A LIGHT SYSTEM

(71) Applicant: SCHREDER S.A., Bruxelles (BE)

(72) Inventors: John Witczak, Liege (BE); Marie Carpentier, Liege (BE); Vincent Lang, Liege (BE)

(21) Appl. No.: 19/112,405

(22) PCT Filed: Sep. 15, 2023
(86) PCT No.: PCT/EP2023/075507

§ 371 Date: Mar. 17, 2025

(30) Foreign Application Priority Data
Sep. 15, 2022 (NL) 2033037

(51) Int. Cl. H05B 47/155; F21V 14/00; F21Y 115/10; H05B 45/10; H05B 45/20; H05B 45/345; H05B 47/17; H05B 47/18; H05B 47/19

(52) U.S. Cl. CPC H05B 47/155; F21V 14/006; H05B 45/10; H05B 45/20; H05B 45/345; H05B 47/17; H05B 47/183; H05B 47/19; F21Y 2115/10

(57) ABSTRACT

A control unit for a light system, said control unit being configured for being electrically connected between a driver and at least two sets of one or more light emitting elements, said control unit being provided with a communication port configured to receive an input control signal and/or to emit an output control signal; an input port configured to receive a light supply signal from the driver to power the at least two sets; and at least two output ports configured to be connected to the at least two sets; wherein the control unit is configured to transform the light supply signal into at least two light supply output signals based on the input control signal and/or based on stored control instructions, said at least two light supply output signals being delivered to the at least two output ports.

### CROSS-REFERENCE TO RELATED APPLICATIONS

This application is the United States National Stage of International Patent Application No. PCT/EP2023/075507 filed Sep. 15, 2023, which claims priority to Netherlands Patent Application No. 2033037 filed Sep. 15, 2022, the disclosures of which are incorporated by reference in their entirety herein.

### FIELD OF INVENTION

The field of the invention relates to control units for light systems, in particular for outdoor or industrial luminaire systems, and more in particular luminaire systems with adjustable light color and/or light intensity and/or light distribution. Further, the field of the invention relates to light systems comprising such control units.

### BACKGROUND

LED devices have an increasing number of applications. Devices that are able to emit white light are especially interesting due to their potential in replacing conventional light sources, e.g. halogen, fluorescent, incandescent lights.

Existing luminaire systems typically comprise a plurality of light elements, for example LED elements, one or more drivers functioning as one or more current sources for driving the plurality of light elements, and a control module for controlling the driving by the one or more drivers.

By using control modules built into the light systems, modern light systems offer a plurality of operating and control possibilities for adjusting or optimizing lighting conditions. For example, brightness, light color and spectrum, light temperature, light distribution, etc. can be set depending on the situation. For example, it is known to control the driving of a plurality of red (R), green (G) and blue (B) LEDs to generate colored light or white light. It is also known that tunable white technology, which is beneficial for health, productivity and/or comfort, provides the ability to choose the color temperature (warm, neutral or cool). In tunable white technology, light from cool white and warm white LEDs may be mixed to cover a color palette e.g. from 2,700 to 6,500 Kelvin. To that end a driver with intelligent technology and a wide dimming range may be provided, wherein the driver has two output channels to control cool and warm white LEDs. Similarly, systems exist that are capable of controlling three channels for RGB or four channels for RGBW.

Some existing systems use separate drivers for driving different groups of LEDs of the light system. Such systems have the disadvantage of an increased space and cost, for the drivers.

Other existing systems, sometimes called multi-channel or multi-branch systems, use a single driver in combination with switching elements which are controlled by a control module to switch on/off certain light elements independently of other light elements. Often pulse width modulation techniques are used to control the switching elements in order to switch on/off a channel or branch with one or more light elements. In such systems, the power that needs to be provided by the single driver is the sum of the power that is needed in each of the branches or channels. In other words, the driver has to be able to cope with power changes. Problems encountered with such systems are amongst others flickering during switching, a current in the branches which is too high after switching. Also, these problems may be different depending on the type of driver that is being used.

### SUMMARY

The object of embodiments of the invention is to provide a control unit for a light system, allowing to achieve a more flexible and modular light system, and in particular a control unit that can be used to enhance existing light systems with a standard driver. More in particular, it is desirable to provide a control unit capable of achieving a light system having at least two sets or branches of one or more light emitting elements, wherein the control unit is capable of controlling the powering of the at least two sets of one or more light emitting elements of the light system in an improved manner.

According to a first aspect, there is provided a control unit for a light system. The control unit is configured for being electrically connected between a driver and at least two sets of one or more light emitting elements of the light system. The control unit is provided with a communication port which is configured to receive an input control signal and/or to emit an output control signal. The control unit is further provided with an input port which is configured to receive a light supply signal originating from the driver to power the at least two sets of light elements. The control unit is further provided with at least two output ports. These output ports are configured to be connected to the at least two sets of light elements. The control unit is configured to transform the light supply signal into at least two light supply output signals that are delivered to the at least two output ports. The light supply signal is transformed based on the input control signal and/or based on stored control instructions.

Thus, in embodiments of the invention, the control unit allows light systems with at least two channels (associated with the at least two sets of one or more light emitting elements) to be driven by a single standard driver. Also, the control unit can operate well with different types of drivers, resulting in a flexible modular light system. The control unit may be flexible in the number of channels it can control such that it can be adapted to light systems with at least two different branches or channels whose color temperature and/or light intensity can be varied. Since the control unit is configured to deliver at least two light supply output signals, the control unit may be used in light systems that comprise at least two different branches or channels, such as tunable-white light systems. The different branches or channels can then be controlled independently such that the light color temperature and/or intensity and/or distribution of the light output can be varied. By light distribution, it is meant the distribution generated by the light emitted by the at least two sets of one or more light emitting elements, through one or more optical elements, if present. The light distribution is delimited by a conical envelope, typically having a non-circular conical shape, containing the light leaving the one or more optical elements or the at least two sets of one or more light emitting elements if no optical elements are present. The light distribution represents the emission directions and the intensity variations of the light within the envelope.

Additionally, since the control unit is able to transform a single-channel light supply signal into at least two light supply output signals, the control unit is also flexible in that it may be used with different types of drivers, more particularly with different types of drivers that output single-channel light supply signals. The control unit may thus avoid the need for several drivers emitting single-channel light supply signals to power the different branches or channels. Furthermore, said control unit may also avoid the need for adapting the type of light elements of the light system to the available driver.

Furthermore, since the transformation of the light supply signal is performed based on an input control signal and/or based on stored control instructions, the control unit is also flexible in that the light output of the at least two sets of one or more light emitting elements may be controlled by suitably connecting the communication port and/or by suitably programming the control unit with control instructions. The programming may be done e.g. with near field communication (NFC), e.g. during manufacturing or upon installation. Also, in use, the control instructions may be reprogrammed.

According to a preferred embodiment, the control unit may be provided with a supply input port configured to receive power for powering the control unit. Preferably, the power signal may be received from the driver. Often, drivers are provided with an auxiliary supply output port and the supply input port of the control unit may then be connected to such auxiliary supply output port. Preferably, the power received through the supply input port may be a DC voltage.

In this way, the control unit may be supplied with power in any suitable manner. In the example of a driver that is provided with an auxiliary supply output port, the control unit may draw the power for powering the control unit from the driver, which may avoid the need for an additional power source.

Preferably, the at least two output ports of the control unit comprise at least three output ports, more preferably, at least four output ports.

In this way, by providing at least three, preferably at least four, output ports, the control unit may be used in a plurality of different types of light systems, and in particular in light systems having up to three or up to four channels for driving in a controlled manner up to three or up to four sets of one or more light emitting elements. Thus, the control unit has the flexibility of being able to operate well within different types of multi-channel light systems.

According to an embodiment, the at least two output ports of the control unit comprise at least three output ports and the control unit is configured to transform the light supply signal into three light supply output signals based on the input control signal. The light supply output signals are delivered to the three output ports and may form e.g. an RGB multi-channel signal.

In this way, the control unit may control light systems that comprise three channels or branches, such as, for example, light systems comprising RGB channels. In such example, the control unit may allow the color output to be varied in several different ways, optionally including generating white light. Such variation may be controlled through the input control signal. Moreover, since said control unit may control three different channels or branches associated with three sets of one or more light emitting elements, the control unit allows the light distribution output to be varied in several different ways. In an example of a light system comprising three different sets of LEDs, such as three different groups of LEDs connected in series, the light distribution output may be varied by varying the three light supply output signals of the control unit in a different manner.

According to an embodiment, the at least two output ports of the control unit may comprise an output control port providing a supply output signal for another component which is not a light, and this supply output signal may also be based on the input control signal. For example, this supply output signal may be a signal supplied to an actuator to control a position of an optical element relative to one or more lighting elements of the at least two sets of one or more lighting elements.

Examples of systems which allow relative movement of an optical element relative to one or more lighting elements are disclosed in patent specifications WO2020025427A1, WO2019134875A1, WO2020136202A1, WO2020136200A1, WO2020136205A1, WO2020136203A1, WO2020136204A1, WO2020136197A1 and WO2020136196A in the name of the applicant which are included herein by reference.

According to a second aspect, there is provided a control unit for a light system, said control unit being configured for being electrically connected between a driver and at least one set of one or more light emitting elements and at least one further component, e.g. an actuator to control a position of an optical element relative to one or more lighting elements of the at least one set of one or more lighting elements, said control unit being provided with
a communication port configured to receive an input control signal and/or to emit an output control signal;
an input port configured to receive at least one supply signal from the driver to power the at least one set and the at least one further component; and
at least two output ports configured to be connected to the at least one set and the at least one further component;

wherein the control unit is configured to transform the at least one supply signal into at least two supply output signals based on the input control signal and/or based on stored control instructions, said at least two supply output signals being delivered to the at least two output ports.

In an exemplary embodiment the component is an actuator to control a position of an optical element relative to one or more lighting elements of the at least one set of one or more lighting elements.

In another exemplary embodiment, the component is an actuator to control a position of a sensor of the light system.

Preferred features of the first aspect may also be combined with features of the second aspect.

According to an embodiment, the at least two output ports of the control unit comprise at least four output ports and the control unit is configured to transform the light supply signal into four light supply output signals based on the input control signal. The light supply output signals are delivered to the four output ports and may form e.g. an RGBW multi-channel signal.

In this way, the control unit may control light systems that comprise four channels or branches, such as, for example, RGBW channels. In the example of a light system comprising an RGBW channel, the control unit may allow to vary the color output of the light system, including generating white light, as well as varying the temperature of the white light. Such variation may be controlled through the input control signal. Moreover, since the control unit may control four different channels or branches, the control unit may allow the light distribution output to be varied in several different ways. In the example of a light system comprising four different sets of LEDs, such as four different groups of LEDs connected in series, the light distribution output may be varied by varying the four light supply output signals of the control unit. Thus, the control unit allows to vary the light distribution output through the input control signal.

According to a preferred embodiment, the control unit may be configured to transform the light supply signal into at least two tunable white channel signals based on the input control signal.

For example, the light intensity of one or more cool white LEDs and the intensity of one or more warm white LEDs may be controlled independently, using two tunable white channel signals based on the input control signal. In this way the color temperature of the mixed light emitted by the one or more cool white LEDs and one or more warm white LEDs can be adjusted. The input control signal for this type of control may, for example, be encoded in a DALI Type 6 standard or DALI Type 8 standard. In DALI Type 6, the light intensity is set per color (warm/cool white light), i.e. two addresses are needed for tunable white. In DALI Type 8, a dimming value (i.e. a light intensity value) and a color value of the desired mixed output signal is set, and the control unit will determine the light supply output signals needed to achieve the specified color and intensity. The control unit may be configured for interpreting these standards used for the input control signal and of transforming the light supply signal accordingly in order to achieve the two light supply output signals.

In an embodiment, the control unit may be configured to detect whether the input control signal is a DALI Type 6 or Type 8, and may then optionally generate an output control signal for controlling the driver, see further.

According to an embodiment, the control unit is configured to transform the light supply signal into two tunable white channel signals associated with two sets for generating a first light distribution with a controllable color and/or intensity and two further tunable white channel signals associated with two further sets for generating a second light distribution with a controllable color and/or intensity, said second light distribution being different from the first light distribution. Preferably, the control unit is configured to adjust the power of the two tunable white channel signals relative to the power of the two further tunable white channel signals so as to adjust a combined light distribution of the four sets comprising the two sets and the two further sets.

In this way not only the color (warm white/cool white) but also the light distribution of the emitted light beam may be changed. In some embodiments only the light intensity may be changed to change the combined light distribution or only the color may be changed to change the combined light distribution. For example, during a first time period, the two further sets may be switched off so that only the first light distribution determines the output light beam whilst during a second time period all sets may be switched on so that the output light beam is a combination of the first and second light distribution.

According to a preferred embodiment, the control unit is configured to communicate through the communication port using any one or more of the following protocols: I2C, UART, DALI such as DALI2, 0-10V, 1-10V.

The advantage of I2C, UART is that those protocols are rather simple protocols, resulting in a control unit which is relatively simple to implement. Also, existing drivers may be able to communicate through I2C or UART, so that they can output the control input signal which is received at the communication port of the control unit. DALI2 has the advantage of being a well-recognized protocol in lighting, allowing the control unit to receive directly DALI signals, e.g. from a DALI bus. In a possible embodiment, when using DALI, the control unit may function as a master controlling the driver through an output control signal as will be explained below.

According to a preferred embodiment, the input port of the control unit may be configured to receive a light supply signal in the form of a single-channel LED signal, i.e. a single signal to power one set of LEDs, typically comprising a string of LEDs. The single-channel LED signal may preferably be an electric current. The light supply signal is received from the driver, preferably a constant current driver, optionally a dimmable constant current driver.

In this way, the control unit may be used in multi-channel light system with a driver that may be of different types, more particularly with any driver that output a single-channel light supply signal. The control unit may thus avoid the need for several drivers emitting single-channel light supply signals to power the different branches or channels of such types of light systems. Furthermore, the control unit may also avoid the need for adapting the type of light elements of the light system to the available driver.

According to a preferred embodiment, the control unit may be configured to deliver a multi-channel LED signal to the at least two output ports, i.e. multiple signals to power multiple sets of LEDs, each set typically comprising a string of LEDs. Said multi-channel LED signal may preferably be in the form of at least two electric currents.

According to a preferred embodiment, the control unit may comprise a storage means which stores the control instructions. Preferably, the control instructions define how to transform the light supply signal into the at least two light supply output signals, preferably based on the input control signal. However, the control instructions may also contain control profiles in function of time or in function of another parameter, in which case the transformation may be done without using an input control signal or based on a combination of an input control signal and another parameter.

The control instructions may be programmed and stored at any time, e.g. during the production of the control unit, during the installation of the control unit in the light system or even after the installation. The instructions may be received wirelessly, e.g. via NFC, but may also be received as an input control signal through the input port. The instructions may be modified at any time, for example through reprogramming information carried by the input control signal. In this way, the control unit is flexible and may be adapted and (re) programmed to operate with different types of drivers, different types of multi-channels light modules and different input control signal protocols. By storing said information, the control unit may operate even without receiving any input control signal, for example in a default mode.

Optionally, the control instructions comprise one or more of: a dimming profile defining a dimming level in function of at least one parameter, such as time and/or a sensed value and/or a color value, such as a color temperature, and/or the input control signal; a color profile defining a color in function of at least one parameter, such as time and/or a sensed value and/or the input control signal; a light distribution profile defining a light distribution parameter in function of a parameter, such as time and/or a sensed value and/or a color value and/or the input control signal.

Such dimming and/or color and/or light distribution profiles may be used by the control unit in function of any parameter. Also, it is possible to use the input control signal to control the color and the intensity and to store only a light distribution profile. The light distribution profile could e.g. indicate, in function of time or in function of another parameter such as a sensed value, which set(s) need to be switched on and how the intensity should be divided between the set(s) that need to be switched on.

According to an embodiment, the control unit may be configured to generate an output control signal for the driver based on the received input control signal and/or on the stored control instructions.

Additionally, the control unit may be configured to emit said output control signal through the communication port to the driver.

In other words, the control unit may generate an output control signal to pilot the driver. The output control signal may be configured so as to receive from the driver, a light supply signal desired by the control unit for powering the at least two sets of one or more light emitting elements. For example, the control unit may receive a DALI2 input control signal from a control module (e.g. a Zhaga or NEMA controller) or from a DALI bus, and based on the DALI2 input control signal, the control unit may request the driver to provide a light supply signal with a dimming level which is based on a dimming level included in the input control signal. In an alternative embodiment, see further, the DALI2 input control signal may be received both at the control unit and the driver.

The control unit may be further provided with at least one auxiliary port configured to receive at least one auxiliary signal. The auxiliary signal may be a digital or an analog signal, such as a signal of a sensor or a controller or another external device. The control unit may be configured to transform the light supply signal into the at least two light supply output signals further based on the at least one auxiliary signal. In this way the control unit may be connected to other devices such as sensors or human interface devices and may take into account data received from such devices for performing the transforming.

In a possible embodiment, the input control signal and/or the output control signal is a synchronization signal for synchronizing the control unit with the driver.

By synchronizing the control unit and the driver, a hybrid system may be obtained where both the control unit and the driver have some autonomy. For example, the driver could operate using a stored dimming profile, without the need for receiving a control signal from the control unit of from a DALI bus, and the control unit could operate based on a stored color profile.

Preferably, the control unit is provided with an antenna configured to receive the stored control instructions wirelessly, e.g. through NFC.

According to a third aspect of the invention, there is provided a light system comprising any one of the above described embodiments of the control unit, and at least one set of one or more light emitting elements, preferably at least two sets of one or more light emitting elements. Each set of one or more light emitting elements is connected to an output port of the at least two output ports of the control unit. Optionally, the light system may also comprise another component, such as an actuator connected to an output port of the at least two output ports.

According to a preferred embodiment, the light system may additionally comprise one or more optical elements for each set of one or more light emitting elements.

In this way, the resulting light distribution of the light system may be tuned. For example, a different color and/or a different light distribution may be emitted depending on the optical elements that are used. The optical elements may be optical lenses, which are typically encountered in outdoor luminaire systems, mirrors, reflectors, backlights, prisms, collimators, diffusors or any other optical element of the like. The optical elements may be used to modify the light output of the light elements, for example for modifying the light intensity distribution of the light output. The optical elements may be different for each of the light elements and/or for each of the sets. In this way, depending on the control scheme, i.e. depending on the at least two light supply output signals that power the at least two sets of light emitting elements, the light distribution may have a first conical envelope and/or a first color in a first scheme and the light distribution may have a second conical envelope and/or a second color in a second scheme.

Examples of suitable optical elements, and especially modular optical systems, are disclosed in PCT patent specifications WO2020074229A1, WO2020136197A1, WO2022023441A1 and in NL patent specification N2030243, all in the name of the applicant, which are included herein by reference. Also, side emitting LEDs in combination with suitable optics may be used, as disclosed for example in NL patent specification N2032294 in the name of the applicant which is included herein by reference.

Alternatively, the one or more optical elements could be a transparent or translucent cover having a varying profile or varying optical properties (e.g. variation of thickness, transparency, diffusivity, reflectivity, refractivity, color, etc.).

The one or more optical elements may also comprise one or more light shielding structures complying with a certain glare classification, e.g. the G classification defined according to the CIE115: 2010 standard and the G* classification defined according to the EN13201-2 standard. The light shielding structures may be configured for reducing a solid angle of light beams of the plurality of light elements by cutting off or reflecting light rays having a large incident angle, thereby reducing the light intensities at large angles and improving the G/G* classification of the luminaire system. The one or more light shielding structures may be an integral part of a lens plate, or may be provided as one or more separate optical elements. When they are provided as one or more separate optical elements, the one or more light shielding structures may be mounted on a lens plate. Examples of such shielding structures and similar optical elements are disclosed in patent specifications N2021671, WO2020249684A1, WO2021186058A1, N2025166, and WO2020058282A1, in the name of the applicant, which are included herein by reference.

Preferably, the light system further comprises a driver. The driver is provided with an output port and optionally also with a communication port. The output port of the driver is connected to the input port of the control unit and the driver is configured to deliver the light supply signal to the control unit through the output port.

In an exemplary embodiment, the communication port of the driver may be connected to the communication port of the control unit. The communication port may be configured to receive the output control signal of the control unit. The driver may then be configured to generate the light supply signal based on the output control signal, as explained above.

In this way, the driver is used as a slave to the control unit. In other words, the control unit may pilot the driver to generate any light supply signal desired by the control unit for powering at least two sets of one or more light emitting elements. The output control signal that is used to pilot the driver may for example be based on the input control signal received by the control unit and/or may be based on a profile stored in the storage means of the control unit. The light supply signal is generated based on the output control signal, such that effectively, the light supply signal may be controlled by the control unit. The control unit then plays the main role in controlling the light system.

According to an embodiment, the control unit may emit an output control signal which comprises a dimming control signal. Additionally, the driver may be configured to determine an amplitude and/or a duty cycle and/or a frequency of the light supply signal in function of said dimming control signal.

In this way, the driver may be configured to reduce the total light supply signal power, which effectively reduces the total light intensity output of the light system, i.e. to dim the light system.

According to an embodiment, the control unit may receive an input control signal which comprises a dimming control signal and/or a color control signal and/or a light distribution control signal. Additionally, the control unit may be configured to determine the output control signal in function of the dimming control signal and/or a color control signal and/or a light distribution control signal.

In this way, the dimming may be dependent on the input control signal which may be a signal based on e.g. on the environmental conditions and/or a desired light setting. Outdoor situations that may require such a dimming may be e.g. the presence of a nocturnal animal, or the presence of inclement weather conditions such as fog, or the dimming during the night in a city center in order to reduce light pollution at night causing discomfort for the inhabitants.

According to an embodiment, the driver is provided with at least one auxiliary control port configured to receive at least one auxiliary control signal, such as an analog or a digital signal and the driver is configured to generate the light supply signal based on the at least auxiliary control signal. The auxiliary control signal may be a signal received from a sensor or a controller, e.g. a NEMA controller, or from another external device.

The communication port of the driver may be configured to deliver the input control signal to the communication port of the control unit, wherein the driver is configured to generate the input control signal based on the at least one auxiliary control signal.

The at least one auxiliary control port may comprise a control input port. The control input port is configured to receive a first control signal. For example, the driver may be configured to communicate through the control input port using any one or more of the following protocols: DALI such as DALI2, 0-10V, I2C, UART, 1-10V. Additionally, the driver may be configured to generate the light supply signal based on the first control signal received at the control input port.

In this way, the driver directly receives the first control signal which, for example, may originate from an external device and which contains the necessary information for the driver to deliver the light supply signal that powers the at least two sets of one or more light emitting elements. The control unit may then transform said light supply signal in several different ways, for example, based on the information stored in storage means of the control unit or based on the input control signal which may or may not be based on the first control signal, see further.

According to an embodiment, the driver may be configured to generate the input control signal based on the at least one auxiliary control signal, and in particular based on the first control signal.

In this way, the control unit is used as a slave to the driver. In other words, the driver may pilot the control unit to generate light supply output signals for powering the at least two sets of one or more light emitting elements. Indeed, since the light supply signals are transformed based on the input control signal coming from the driver, the driver effectively plays a main role in controlling the light system.

According to an embodiment, the at least one auxiliary control signal may comprise a dimming control signal. Additionally, the driver of the light system may be configured to determine an amplitude and/or a duty and/or a frequency of the light supply signal in function of said dimming control signal.

The dimming control signal may be dependent e.g. on an environmental situation. As mentioned above, environmental situations that may require such a dimming may be e.g. the presence of a nocturnal animal, or the presence of inclement weather conditions such as fog or rain, or desired dimming during the night in a city center in order to reduce light pollution at night causing discomfort for the inhabitants.

According to an embodiment, the driver of the light system may comprise a storage means that stores a dimming profile. Additionally, the driver may be configured to generate the light supply signal based on said dimming profile. Such dimming profile may be used by the driver in function of time and/or in function of a control signal. Such control signal could be e.g. a sensed signal.

In this way, the driver may not always need a first control signal to generate the light supply signal. The dimming profile(s) may also be programmed and stored at any time, e.g. during the production of the driver, during the installation of the driver in the light system or even after the installation. The dimming profile(s) may also be modified at any time, for example through reprogramming information carried by the first control signal. By storing said information, the driver and hence the light system may operate without receiving any further first control signal, for example in a default mode stored in the storage means.

According to an embodiment, the driver of the light system may be provided with an auxiliary supply output port. The driver may be further configured to generate a supply signal, preferably a DC voltage, on said auxiliary supply output port. Additionally, the auxiliary supply output port may be electrically connected to the supply input port of the control unit.

In this way, the control unit and the driver may be powered with only one power source. This may avoid the need for an additional power cable running through the light system for powering the control unit and may improve the cabling within the light system.

According to a preferred embodiment, the light system may be an outdoor or industrial luminaire. More preferably, the light system may be a streetlight. By outdoor and industrial luminaire, it is meant a luminaire adapted for roads, tunnels, industrial plants, stadiums, airports, harbors, rail stations, campuses, parks, cycle paths, pedestrian paths, or pedestrian zones for example, and industrial and outdoor light systems can be used notably for the lighting of an outdoor area, such as roads and residential areas in the public domain, private parking areas and access roads to private building infrastructures, warehouses, industry halls, etc.

According to an exemplary embodiment the light system comprises a pole and a luminaire head attached to the pole and the at least one set of one or more lighting elements is arranged in the luminaire head. The control unit may be arranged for example in or on the luminaire head and/or the driver may be arranged in or on the luminaire head.

According to another exemplary embodiment, the light system comprises multiple pole modules, arranged for example one above the other, and the at least one set of one or more lighting elements is arranged in a pole module of said multiple pole modules. The control unit may be arranged for example in or on a pole module and/or the driver may be arranged in or on a pole module.

The controller or control module or external device mentioned above may be a pluggable module containing different control blocks and/or sensors, e.g. a light sensor for sensing the light level of ambient light to automatically control the light sources of the lighting equipment. For uniformity throughout the lighting industry, electrical receptacles for receiving such external modules are mostly made according to specific standards such as standards approved by American National Standards Institute, Inc. (ANSI). Such receptacles are typically mounted on the top of a housing or in an opening in the housing of the lighting equipment and are electrically connected to various components of the lighting equipment. The receptacle has a connection interface located on an external side of the housing, so that an external module can be plugged into the receptacle to provide control for the lighting equipment. Preferably, the receptacle and the external control module fulfil the requirements of the ANSI C136.10-2017 standard or of the ANSI C136.41-2013 standard or of the Zhaga Interface Specification Standard (Book 18, Edition 1.0, July 2018, see https://www.zhagastandard.org/data/downloadables/1/0/8/1/book_18.pdf).

Embodiments of the invention may be used in combination with light systems such as the light systems disclosed in patent specifications WO2019020366A1, WO2020165284A1, WO2020173836A1, WO2021130275A1 in the name of applicant, which are included herein by reference.

### BRIEF DESCRIPTION OF THE FIGURES

The accompanying drawings are used to illustrate presently preferred non-limiting exemplary embodiments of control units and light systems of the present invention. The above and other advantages of the features and objects of the invention will become more apparent, and the invention will be better understood from the following detailed description when read in conjunction with the accompanying drawings, in which:

FIG. 1a is a block diagram of an exemplary embodiment of a light system comprising a driver, a control unit and two sets of one or more light emitting elements;

FIG. 1b is a block diagram of another exemplary embodiment of a light system comprising a driver, a control unit powered by the driver and two sets of one or more light emitting elements;

FIG. 2 illustrates schematically an exemplary embodiment of a control unit, its ports and the signals received and emitted from these ports;

FIG. 3 illustrates schematically an exemplary embodiment of a driver, its ports and the signals received and emitted from these ports;

FIG. 4 is a block diagram of an exemplary embodiment of a light system comprising a driver, a control unit and two sets of one or more light emitting elements;

FIG. 5a is a block diagram of another exemplary embodiment of a light system comprising a driver and a control unit, said driver being used as a slave to the control unit;

FIG. 5b is a block diagram of another exemplary embodiment of a light system comprising a driver and a control unit comprising a storage means, said driver being used as a slave to the control unit;

FIG. 5c is a block diagram of another exemplary embodiment of a light system comprising a driver comprising a storage means, a control unit and two sets of one or more light emitting elements;

FIG. 6a is a block diagram of another exemplary embodiment of a light system comprising a driver, and a control unit being used as a slave to the driver;

FIG. 6b is a block diagram of another exemplary embodiment of a light system comprising a driver, a control unit and two sets of one or more light emitting elements;

FIG. 7 illustrates schematically a light module comprising four sets of light emitting elements, in order to generate a tunable white light beam with a variable light distribution; and FIGS. 8a and 8b illustrate control profiles in function of time for controlling the light module of FIG. 7.

FIG. 9 illustrates schematically an exemplary embodiment of a control unit and its internal components.

### DETAILED DESCRIPTION OF EMBODIMENTS

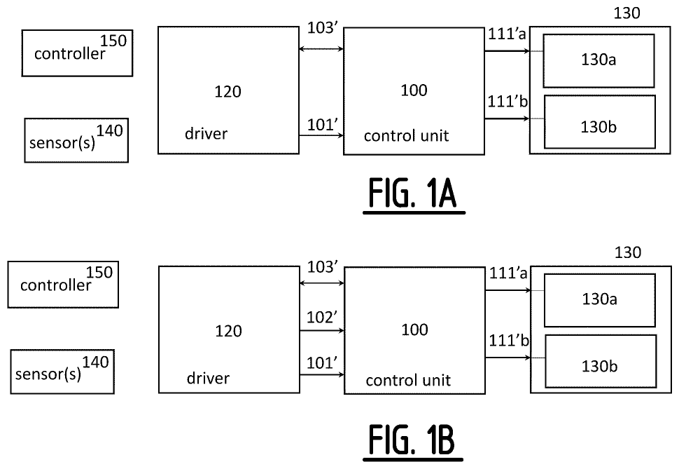

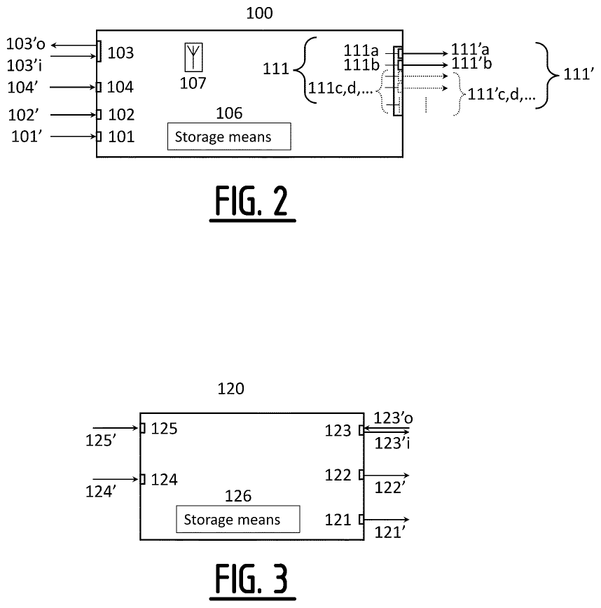

FIG. 1a is a block diagram of an exemplary embodiment of a light system. The light system comprises a driver 120, a control unit 100 and a light module 130 comprising at least two sets 130a, 130b of one or more light emitting elements, and optionally a controller 150 and one or more sensors 140 or other external devices such as human interface devices. Optionally, the controller 150 and/or the one or more sensors 140 may be provided as an external pluggable module as described above.

The driver 120 is typically implemented as a separate unit, i.e. a separate entity with its components included in a common housing. The driver 120 provides the control unit 100 with a light supply signal 101′ to power via the control unit 100 the two sets of light elements 130a, 130b. The driver 120 is further connected to the control unit 100 and may exchange information such as an input control signal 103′. The control unit 100 is connected to the two sets of light emitting elements 130a, 130b and provides the two sets of light emitting elements 130a, 130b with light supply output signals 111′a, 111′b to power the two sets of light emitting elements 130a, 130b.

The driver 120 may be a simple state-of-the-art driver with a dimming functionality. However, the driver 120 may also be a more advanced driver capable of realizing one or more driving functionalities different than the main (basic) driving functionality. Optionally the driver 120 may be provided with one or more pluggable modules to enhance the functionalities of the driver, as described in WO2017220690A1 or WO2020064864 in the name of the applicant which are included herein by reference.

The driver 120 can be adapted to provide driving signals for different types of light emitting devices, preferably for one or more light emitting diodes. The driver 120 may comprise a driver housing, a driver circuitry, and a receiving means. The driver housing is provided with input connector elements (ports; not shown) for connection to a power supply. The driver circuitry is arranged in the driver housing and is configured to generate the light supply signal 101′. Preferably, the driver circuitry comprises voltage-to-current converter circuitry configured for generating the light supply signal 101′. Such converter circuitry is preferred when the light module 130 comprises light emitting diodes. In that manner, a plurality of light emitting diodes connected in series can be easily provided with a drive current. In alternative embodiments, a voltage-to-voltage converter circuitry may be used. Preferably, the driver circuitry comprises control circuitry configured for controlling the converter circuitry in function of one or more received control signals and/or in function of a stored dimming profile, see further.

The control unit 100 may be connected to the controller 150. To that end the control unit housing may be provided with one or more control connector elements (ports; not shown) for connection to the control unit 100. The controller 150 may be configured to provide the control unit 10 with a control signal, and the control unit 100 may generate the light supply output signals 111′a, 111′b based on the control signal. Alternatively, or in addition, the control unit 100 may store control information and/or may receive control signals directly from one or more sensors 140 and/or from one or more other external devices, and may generate the light supply output signal 111′a, 111′b based on the stored control information and/or based on control signals received from one or more sensors or other external devices. Optionally, the controller 150 may be connected to one or more sensors 140 and may exchange information with said one or more sensors 140.

In addition or alternatively, the driver 120 may be connected to the controller 150. To that end the driver housing may be provided with one or more control connector elements (ports; not shown) for connection to the controller 150. The controller 150 may be configured to provide the driver with a first control signal, and the driver 120 may generate the light supply signal 101′ and/or the input control signal 103′ based on the first control signal. Alternatively, or in addition, the driver 120 may store control information and/or may receive control signals directly from one or more sensors 140 and/or from one or more other external devices, and may generate the light supply signal 101′ and/or the input control signal 103′ based on the stored control information and/or based on control signals received from one or more sensors or other external devices.

FIG. 1b is a block diagram of another exemplary embodiment similar to that of FIG. 1a, of a light system comprising a driver 120, a control unit 100 and a light module 130, and optionally a controller 150, for example an external controller, and one or more sensors 140 or other external devices. In this embodiment, the control unit 100 is configured to receive power 102′ from the driver 120 for powering the control unit 100. Indeed, some types of drivers provide as an output an auxiliary supply voltage (Vaux) which may be used as a voltage supply for the control unit 100. By using the auxiliary voltage supply of the driver 120, it is avoided that a separate protected voltage supply for the control unit is required, resulting in a more compact, robust and cost-efficient solution.

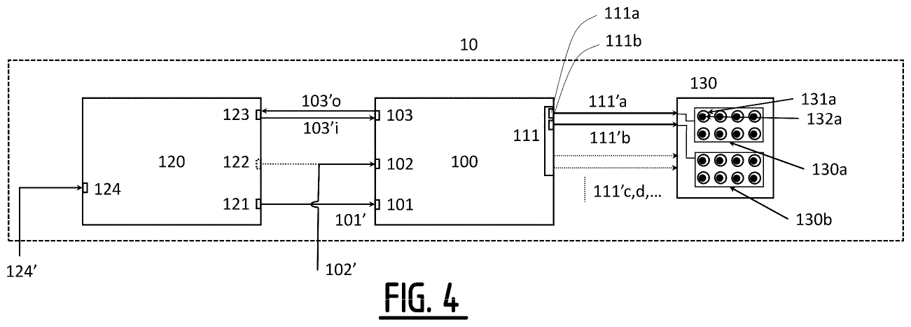

FIG. 2 illustrates schematically an exemplary embodiment of a control unit 100, its ports and the signals received and emitted from these ports. The control unit 100 is provided with a communication port 103, an input port 101 and output ports 111. The communication port 103 is configured to receive an input control signal 103′i and allows the control unit 100 to receive information 103′i from the driver 120 or from any external device, e.g. in any one or more of the I2C, UART or DALI2 protocols. The input port 101 is configured to receive a light supply signal 101′ from the driver 120 which is used by the control unit 100 to power the light module. The output ports 111 are configured to be connected to the light module. The output ports 111 comprise at least two output ports 111a, 111b configured to be connected to the at least two sets of one or more light emitting elements of the light module. The control unit 100 is further configured to transform the light supply signal 101′ into at least two light supply output signals 111′a, 111′b for powering the respective sets of light emitting elements. The transformation is done based on the input control signal 103′i. Additionally, the control unit 100 is configured to deliver the at least two light supply output signals 111′a, 111′b to the said at least two output ports 111a, 111b, such that the at least two light supply output signals 111′a, 111′b can power the respective sets of light emitting elements.

The control unit 100 may be further provided with a supply input port 102. The supply input port 102 is configured to receive power 102′ for powering the control unit 100. The supply signal 102′ may for example be delivered by the driver as explained in connection with FIG. 1b, or may be delivered from an external power device. According to a preferred embodiment, the supply signal 102′ may be a DC voltage.

The control unit 100 may be further configured to generate an output control signal 103′o and deliver said output control signal 103′o to the communication port 103, to be emitted e.g. to the driver or to another external device. The output control signal 103′o may be based on the received input control signal 103′i. The output control signal 103′o may allow the control unit 100 to exchange information 103′ e.g. with the driver or with another external device in any one or more of the I2C, UART or DALI2 protocols and may allow to use the driver or another external device as a slave to the control unit 100.

The control unit 100 may be further provided with a storage means 106. The storage means 106 may store instructions defining how to perform the transformation of the light supply signal 101′ into the at least two light supply output signals 111′a, 111′b based on the input control signal 103′i. The storage means 106 may also store dimming profiles and/or color profiles and/or light distribution profiles. Such dimming profiles and/or color profiles and/or light distribution profiles may specify a light intensity and/or color and/or a light distribution (i.e. which sets to switch on/off and how to divide the light intensity between the sets) to be used in function of another parameter, e.g. in function of time or in function of a sensed parameter (e.g. based a sensed signal received from a sensor such as a light sensor or a motion sensor). These dimming profiles and/or color profiles and/or light distribution profiles may be used by the control unit 100 to perform the transformation of the light supply signal 101′ into the at least two light supply output signals 111′a, 111′b and/or to determine the output control signal 103′o in function of the dimming profile. Hence, the control unit 100 may use the dimming profiles and/or color profiles and/or any other profiles stored in the storage means 106 to perform the transformation and/or to emit the output control signal 103′o. The input control signal 103′i may be used to (re) program and/or modify the information stored in the storage means 106.

The control unit 100 may further be provided with an antenna 107 which may allow the (re) programming and/or the modifying of the information stored in the storage means 106 to be done wirelessly, e.g. through NFC.

The control unit 100 may be further provided with at least one auxiliary port 104 configured to receive at least one auxiliary signal 104′, which may be an analog signal or a digital signal, such as a signal of a sensor or human interface device. The control unit 100 may then be configured to transform the light supply signal 101′ into the at least two light supply output signals 111′a-d further based on the at least one auxiliary signal 104′.

The input port 101 may be configured to receive a light supply signal 101′ from the driver 120 in the form of a single-channel LED signal to power the light module 130. Preferably, the light supply signal 101′ is an electric current.

The control unit 100 may be configured to deliver on the at least two output ports 111 a multi-channel LED signal 111′. Preferably, the multi-channel LED signal 111′ consists of at least two electric currents.

Preferably, the output ports 111 of the control unit 100 comprise at least three output ports 111a, 111b, 111c or more preferably at least four output ports 111a, 111b, 111c, 111d. Each of said output ports 111 are configured to be connected to a different set of the at least three sets, more preferably four sets, of one or more light emitting elements of the light module 130. According to this embodiment, the control unit 100 is further configured to transform the light supply signal 101′ into at least three, preferably at least four, light supply output signals 111′a, 111′b, 111′c, 111′d. The transformation of the light supply signal 101′ is done based on the input control signal 103′i. Additionally, the control unit 100 is configured to deliver the at least three, preferably at least four, light supply output signals 111′a, 111′b, 111′c, 111′d to the said at least three, preferably at least four, output ports 111a, 111b, 111c, 111d, such that the at least three, preferably at least four, light supply output signals 111′a, 111′b, 111′c, 111′d are emitted to the light module 130.

The control unit 100 may be configured to transform the light supply signal 101′ into three or four light supply output signals 111′a, 111′b, 111′c, 111′d based on the input control signal 103′i for forming an RGB multi-channel signal or an RGBW multi-channel signal, respectively, said three or four light supply output signals 111′a, 111′b, 111′c, 111′d being delivered to the three or four output ports 111a, 111b, 111c, 111d.

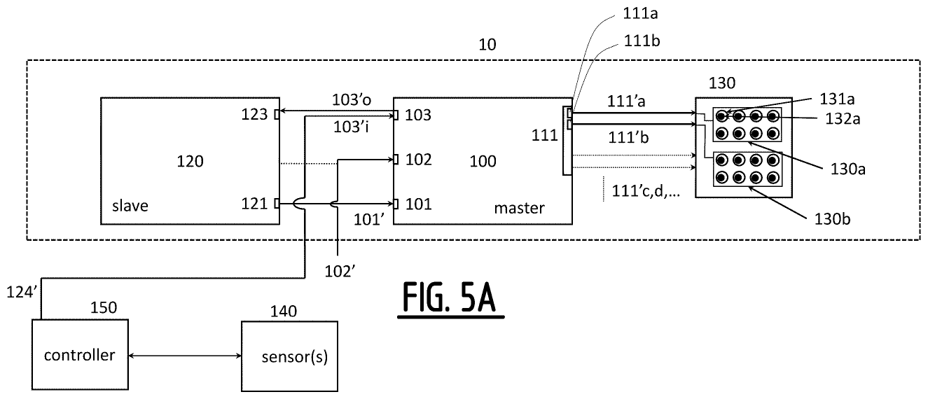

FIG. 3 illustrates schematically an exemplary embodiment of a driver, its ports and the signals received and emitted from these ports. The driver 120 is provided with a communication port 123 and an output port 121. The output port 121 is configured to deliver the light supply signal 101′ to the input port 101 of the control unit 100.

The communication port 123 may be configured to receive the output control signal 103′o from the communication port 103 of the control unit 100. The driver 120 may then be configured to generate the light supply signal 101′ based on the output control signal 103′o. The driver 120 may thus be used as a slave to the control unit 100 to deliver the light supply signal 101′ for powering the light element 130. However, the driver 120 may also function as a master as will further explained below, or both the control unit 100 and the driver 120 may play a main role in the controlling.

The driver 120 may be provided with a control input port 124. The control input port 124 is configured to receive a first control signal 124′. The first control signal 124′ may be encoded in a DALI2 protocol for example, but may also be any other type of control signal, e.g. a control signal received from a controller, see also the controller 150 described above in connection with FIG. 1a, and/or from one or more sensors 140 such as a light sensor and/or a motion sensor and/or from one or more other external devices. The driver 120 may then be configured to generate the light supply signal 101′ based on the first control signal 124′ for powering the light element 130.

The driver 120 may be provided with one or more further auxiliary control ports 125 configured to receive one or more auxiliary control signals 125′, which may comprise an analog signal and/or a digital signal, such as a signal of a sensor or human interface device. The driver 120 may then be configured to generate the light supply signal 101′ based on the one or more auxiliary control signals 125′.

The communication port 123 may be configured to emit the input control signal 103′i to the communication port 103 of the control unit 100. The input control signal 103′i may be encoded e.g. in any one or more of the I²C, UART, 0-10V or DALI2 protocols and may allow to use the control unit 100 as a slave to the driver 120.

The driver 120 may be further provided with an auxiliary supply output port 122. The auxiliary supply output port 122 is configured to generate a supply signal 102′. The supply signal 102′ may be configured for powering the control unit. According to a preferred embodiment, the supply signal 102′ may be a DC voltage.

The first control signal 124′ and/or the output control signal 103′o may comprise a dimming control signal, and the driver 120 may be configured to determine an amplitude and/or a duty cycle and/or a frequency of the light supply signal 101′ in function of the dimming control signal.

The driver 120 may be provided with a storage means 126. Said storage means 126 may store instructions defining how to generate the light supply signal 101′ based on the first control signal 124′ and/or based on the output control signal 103′o. The storage means 126 may also store one or more dimming profiles and/or one or more profiles to control another component which is not a light. These one or more dimming profiles may be used by the driver 120 to determine the light supply signal 101′ optionally further taking into account the dimming control signal included in the first control signal 124′ and/or the output control signal 103′o. The driver 120 may hence use dimming profiles and/or other profiles stored in the storage means 126 to generate the light supply signal 101′ without necessarily needing an output control signal 103′o and/or without necessarily needing a first control signal 124′.

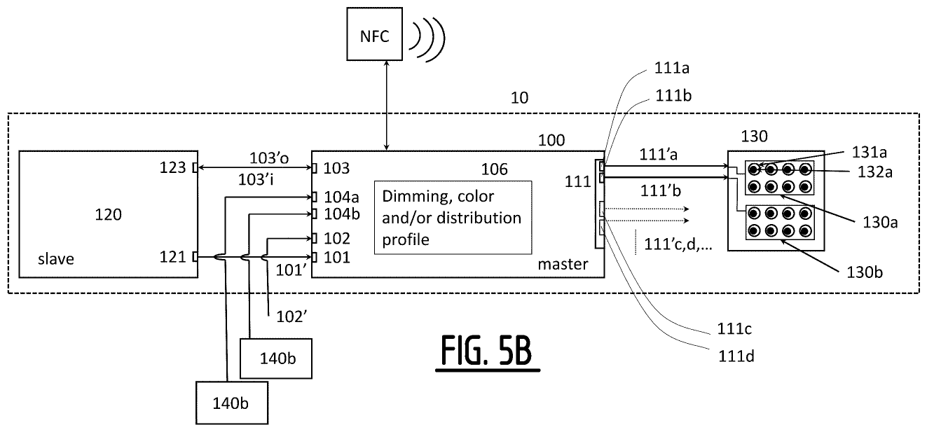

FIG. 4 is a block diagram of an exemplary embodiment of a light system 10 comprising a driver 120, a control unit 100 and a light module 130. The light module 130 comprises at least two sets 130a, 130b of one or more light emitting elements 132a. The driver 120 is provided with a control input port 124, a communication port 123 and an output port 121. The control unit 100 is provided with a communication port 103, an input port 101, a supply input port 102 and output ports 111.

The communication port 123 of the driver 120 is connected to the communication port 103 of the control unit 100. The communication port 123 may be configured to receive an output control signal 103′o which is emitted from the communication port 103 of the control unit 100 and/or may be configured to emit an input control signal 103′i to the communication port 103 of the control unit 100. The control signals 103′ may be encoded e.g. in any one or more of the I2C, UART or DALI2 protocols.

The output port 121 of the driver 120 is connected to the input port 101 of the control unit 100. The output port 121 is configured to emit a light supply signal 101′ which is received by the input port 101 of the control unit 100. The driver 120 is configured to generate the light supply signal 101′ based on the first control signal 124′ and/or based on the output control signal 103′o, for powering the light module 130. The light supply signal 101′ may be in the form of a single-channel LED signal and may preferably be an electric current.

The communication port 103 of the control unit 100 is connected to the communication port 123 of the driver 120. The communication port 103 is configured to receive an input control signal 103′i, which may be originating from the driver 120, or may be originating from an external device. The communication port 103 may also be configured to emit an output control signal 103′o which is received by the communication port 123 of the driver 120. The control signals 103′ may be encoded e.g. in any one or more of the I2C, UART or DALI2 protocols.

The input port 101 of the control unit 100 is connected to the output port 121 of the driver 120. The input port 101 is configured to receive a light supply signal 101′ which is emitted by the output port 121 of the driver 120. The light supply signal 101′ may be in the form of a single-channel LED signal and may preferably be an electric current.

The output ports 111 are configured to be connected to the light module. The output ports 111 comprise at least two output ports 111a, 111b configured to be connected to the at least two sets 130a, 130b of one or more light emitting elements 132a of the light module 130. The control unit 100 is further configured to transform the light supply signal 101′ into at least two light supply output signals 111′a, 111′b. The transformation is done based on the input control signal 103′i. Additionally, the control unit 100 is configured to deliver each of the at least two light supply output signals 111′a, 111′b to the said at least two output ports 111a, 111b, such that each of the at least two light supply output signals 111′a, 111′b is emitted to a different set 130a, 130b of the at least two sets of one or more light emitting elements 132a of the light module 130. For example, the first supply output signal 111′a may be emitted to power the first set 130a while the second supply output signal 111′b may be emitted to the second set 130b. The light module 130 may further comprise one or more optical elements 131a for each set 130a, 130b of light emitting elements 132a, e.g. a first lens plate for the first set 130a and a second lens plate for the second set 130b.

The supply input port 102 of the control unit 100 is configured to receive power 102′ for powering the control unit 100. The supply signal 102′ may be delivered from an external power device or by the driver 120. According to a preferred embodiment, the supply signal 102′ may be a DC voltage. More in particular, the driver 120 may be further provided with an auxiliary supply output port 122 which is configured to deliver a supply signal 102′ for powering the control unit 100. The supply input port 102 of the control unit 100 may then be configured to receive the supply signal 102′ from the driver 120 for powering the control unit 100.

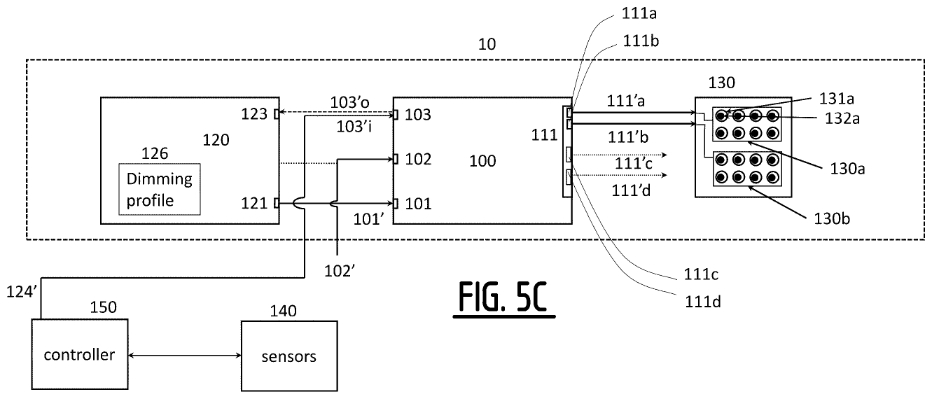

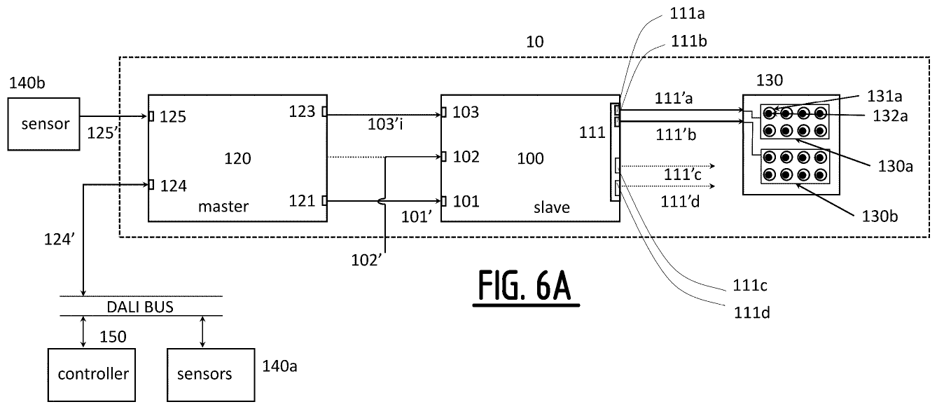

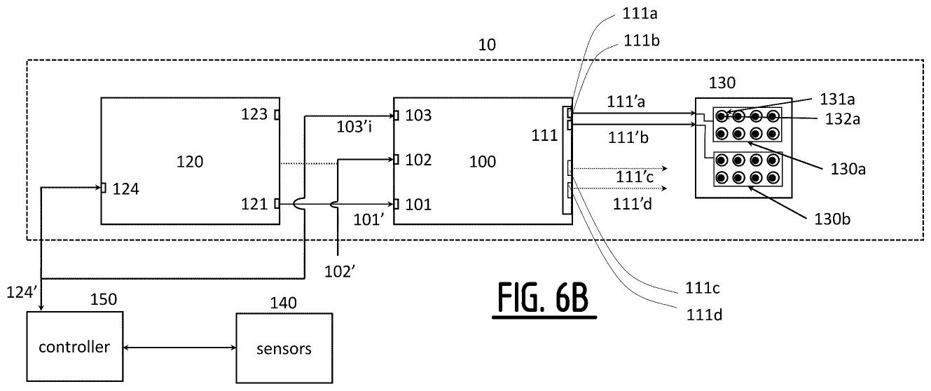

FIG. 5a is a block diagram of another exemplary embodiment of a light system comprising an external controller 150 connected to one or more optional sensors 140, a driver 120, a control unit 100, and a light module 130. The exemplary embodiment of FIG. 5a is similar to the one of FIG. 4, except at least in that the first control signal 124′ is delivered to the communication port 103 of the control unit 100. The input control signal 103′i is thus the first control signal 124′ and originates from an external source such as the controller 150 which may be e.g. a NEMA controller. The control unit 100 is configured to generate an output control signal 103′o based on the received input control signal 103′i and deliver said output control signal 103′o to the communication port 103. The output control signal 103′o is configured to be delivered to the communication port 123 of the driver 120 and may be encoded e.g. in any one or more of the I2C, UART or DALI, e.g. DALI2, protocols or may be a basic 0-10V signal. Thus, the driver 120 is used as a slave of the control unit 100, while the control unit 100 is a slave to the external controller 150.

The output port 121 of the driver 120 is connected to the input port 101 of the control unit 100. The output port 121 is configured to emit a light supply signal 101′ which is received by the input port 101 of the control unit 100. The driver 120 is configured to generate the light supply signal 101′ based on the output control signal 103′o. The light supply signal 101′ may be in the form of a single-channel LED signal and may preferably be an electric current.

FIG. 5b is a block diagram of another exemplary embodiment of a light system comprising a driver 120, one or more optional sensors 140a, 140b, a control unit 100 comprising a storage means 106, and a light module 130. The exemplary embodiment of FIG. 5b is similar to the one of FIG. 5a, except at least in that the control unit 100 is provided with a storage means 106 which stores one or more dimming profiles and/or color profiles and/or light distribution profiles and/or other profiles for another component which is not a light. These one or more dimming and/or color profiles and/or light distribution profiles may be used by the control unit 100 to determine the output control signal 103′o in function of said one or more dimming profiles. The input control signal 103′i may be configured to (re) program the one or more dimming profiles and/or color profiles and/or light distribution profiles and/or any other information which is stored in the storage means 106. Alternatively, the control unit 100 may further be provided with a wireless communication interface which allows the (re) programming and/or the modifying of the information stored in the storage means 106 to be done wirelessly, e.g. through NFC. The control unit 100 is configured to generate the output control signal 103′o and deliver said output control signal 103′o to the communication port 103. The output control signal 103′o is configured to be delivered to the communication port 123 of the driver 120 and may be encoded e.g. in any one or more of the I2C, UART or DALI, e.g. DALI2, protocols or may be a basic 0-10V signal. The driver 120 is configured to determine an amplitude and/or a duty cycle and/or a frequency of the light supply signal 101′ in function of the output control signal 103′o.

The control unit may be further provided with one or more auxiliary ports 104a, 104b each configured to receive an auxiliary signal, preferably an analog signal, such as a signal of a sensor or human interface device 140a, 140b. The control unit may then be configured to transform the light supply signal 101′ into the at least two light supply output signals 111′a-d further based on the one or more auxiliary signals.

In a further developed embodiment of the embodiment of FIG. 4, 5a or 5b, the output ports 111 of the control unit 100 may comprise one or more output ports, e.g. 111c and/or 111d to be connected to one or more other components which are not lights, and the one or more supply output signals 111′c and/or 111′d on the one or more output ports 111c and/or 111d may also be based on one or more control signals, such as control signal 103′i and/or control signals received at auxiliary ports 104a, 104b and/or on data stored in the storage means 106 of the control unit 100. For example, the supply output signal 111c or 111d may be a signal supplied to an actuator to control a position of an optical element relative to one or more lighting elements of the at least two sets 130a, 130b of one or more lighting elements. In such an embodiment the driver 120 may also provide a light supply signal 101′ and a further supply signal (not shown) used to generate the one or more supply output signals 111′c, 111′d for the one or more other components. However, it is also possible to use the light supply signal 101′ for generating the one or more supply output signals 111′c, 111′d for the one or more other components. In some embodiments there may be only one set of one or more lighting elements and one or more other components, such as the actuator.

The exemplary embodiments of FIGS. 5a and 5b illustrate realization modes where the driver 120 is used as a slave to the control unit 100.

FIG. 5c is a block diagram of another exemplary embodiment of a light system comprising a driver 120 comprising a storage means 126, an external controller 150, one or more optional sensors 140, a control unit 100 and a light module 130. The exemplary embodiment of FIG. 5c is similar to the one of FIG. 5a, except at least in that the driver 120 is provided with a storage means 126 which stores one or more dimming profiles and/or one or more other profiles to control one or more components which are not lights and in that the control unit 100 may not deliver any output control signal 103′o through the communication port 103. In this exemplary embodiment, the driver 120 is configured to generate the light supply signal 101′ based on the stored one or more dimming profiles.

The light supply signal 101′ may be in the form of a single-channel LED signal which is transformed by the control unit 100 to power the multi-channel light module 130, and may preferably be an electric current.

The first control signal 124′ originating from the external controller 150 is delivered to the communication port 103 of the control unit 100. The input control signal 103′i is thus the first control signal 124′ and originates from an external device, i.e. the external controller 150. The control unit 100 is further configured to transform the light supply signal 101′ into at least two light supply output signals 111′a, 111′b. The transformation is done based on the input control signal 103′i.

For synchronization purposes, the control unit 100 may still deliver an output control signal 103′ through the communication port 103.

In a further developed embodiment of the embodiment of FIG. 5c, the output ports 111 of the control unit 100 may comprise one or more output ports, e.g. 111c and/or 111d to be connected to another component which is not a light, and the one or more supply output signals 111′c and/or 111′d on those one or more output ports 111c and/or 111d may also be based on one or more control signals, such as control signal 103′i and/or on data stored in the storage means 126 of the driver 120. For example, the supply output signal 111c or 111d may be a signal supplied to an actuator to control a position of an optical element relative to one or more lighting elements of the at least two sets 130a, 130b of one or more lighting elements. In such an embodiment the driver 120 may also provide a light supply signal 101′ and a further supply signal (not shown) used to generate the one or more supply output signals 111′c, 111′d for the one or more other components. However, it is also possible to use the light supply signal 101′ for generating the one or more supply output signals 111′c, 111′d for the one or more other components. In some embodiments there may be only one set of one or more lighting elements and one or more other components, such as the actuator.

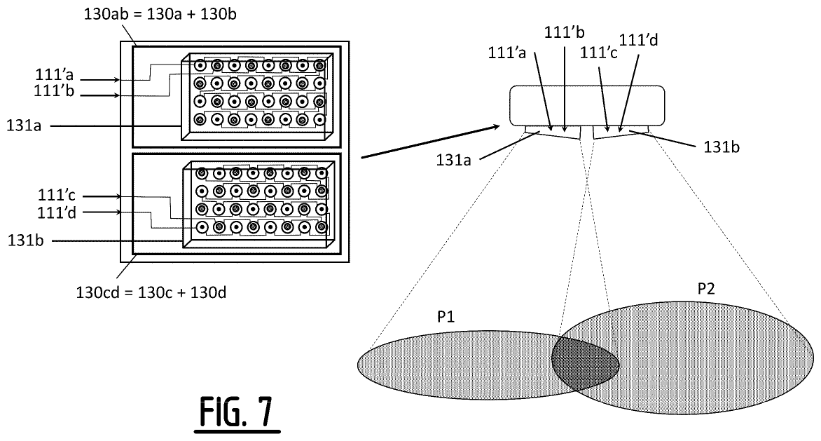

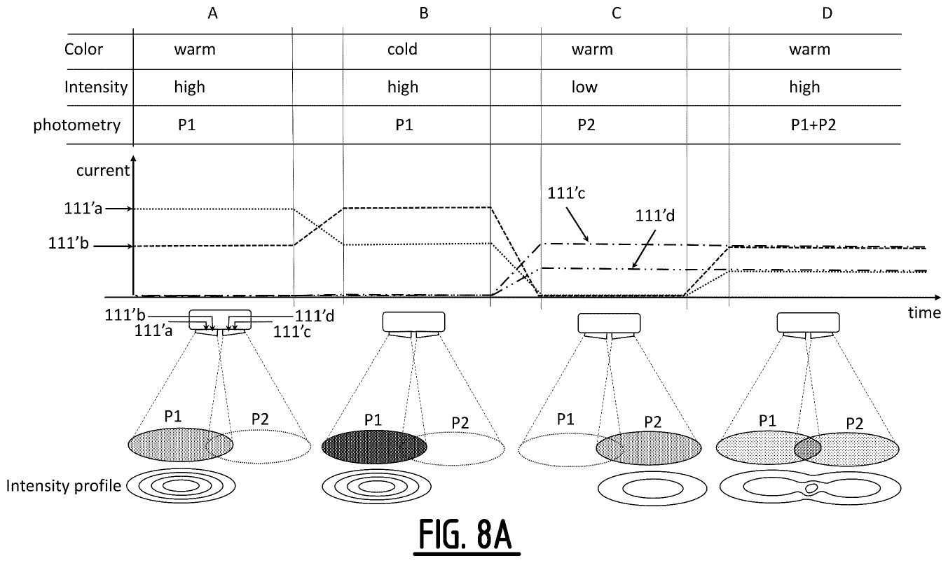

FIG. 6a is a block diagram of another exemplary embodiment of a light system comprising a driver 120, a controller 150, one or more optional sensors 140a, 140b, a control unit 100 being used as a slave to the driver, and a light module 130. The exemplary embodiment of FIG. 6a is similar to the one of FIG. 4, except at least in that the control unit 100 delivers no output control signal 103′o through the communication port 103 and the driver 120 may be connected to one or more sensors 140b through one of its auxiliary ports 125.

In this exemplary embodiment, the control unit 100 is used as a slave to the driver 120. The driver 120 is configured to receive a first control signal 124′ originating from an external controller 150.

The driver 120 is configured to generate the light supply signal 101′ based on said first control signal 124′ for powering the light element 130. The driver 120 is also configured to emit an input control signal 103′i to the communication port 103 of the control unit 100. The input control signal 103′i may be encoded in e.g. the I′C, UART or DALI, e.g. DALI2, protocols or may be a basic 0-10V signal. The control unit 100 is configured to transform the light supply signal 101′ into at least two light supply output signals 111′a, 111′b. The transformation is done based on the input control signal 103′i which typically contains color information.

The driver 120 may be connected to the controller 150 and one or more optional sensors 140a through a DALI bus. The driver 120 may be further configured to generate the light supply signal 101′ based on signals originating from the one or more sensors 140a. One or more further sensors 140b may be connected directly to the auxiliary ports 125 of the driver 120 and delivering a sensor signal 125′ to the driver 120. The one or more optional sensors 140b may be analog or digital sensors.

FIG. 6b is a block diagram of another exemplary embodiment of a light system comprising a driver 120, an external controller 150, one or more optional sensors 140, a control unit 100 and a light module 130. The exemplary embodiment of FIG. 6b is similar to the one of FIG. 6a, except at least in that the driver 120 delivers no input control signal 103′i and in that the input control signal 103′i received by the communication port 103 of the control unit 100 is the first control signal 124′ originating from the external controller 150 instead, i.e. both the driver 120 and the control unit 100 receive the same first control signal 124′, e.g. a DALI2 signal.

The driver 120 is configured to generate the light supply signal 101′ based on said first control signal 124′ originating from the external controller 150. The control unit 100 is configured to transform the light supply signal 101′ into at least two light supply output signals 111′a, 111′b for powering the light module 130. The transformation is done based on the input control signal 103′i, which in this case is the same as the first control signal 124′. For example, the first control signal 124′ may contain dimming information and color information, and the driver 120 may use the dimming information to generate the light supply signal, whilst the control unit 100 may use the color information to transform the light supply signal 101′ into at least two light supply output signals 111′a, 111′b.

In a further developed embodiment of the embodiment of FIGS. 6a and 6b, the output ports 111 of the control unit 100 may comprise one or more output ports, e.g. 111c and/or 111d to be connected to another component which is not a light, and the one or more supply output signals 111′c and/or 111′d on the one or more output ports 111c and/or 111d may also be based on one or more control signals, such as control signal 103′i received from the driver 120 or from the controller 150. For example, the supply output signal 111c or 111d may be a signal supplied to an actuator to control a position of an optical element relative to one or more lighting elements of the at least two sets 130a, 130b of one or more lighting elements. In such an embodiment the driver 120 may also provide a light supply signal 101′ and a further supply signal (not shown) used to generate the one or more supply output signals 111′c, 111′d for the one or more other components. However, it is also possible to use the light supply signal 101′ for generating the one or more supply output signals 111′c, 111′d for the one or more other components. In some embodiments there may be only one set of one or more lighting elements and one or more other components, such as the actuator.

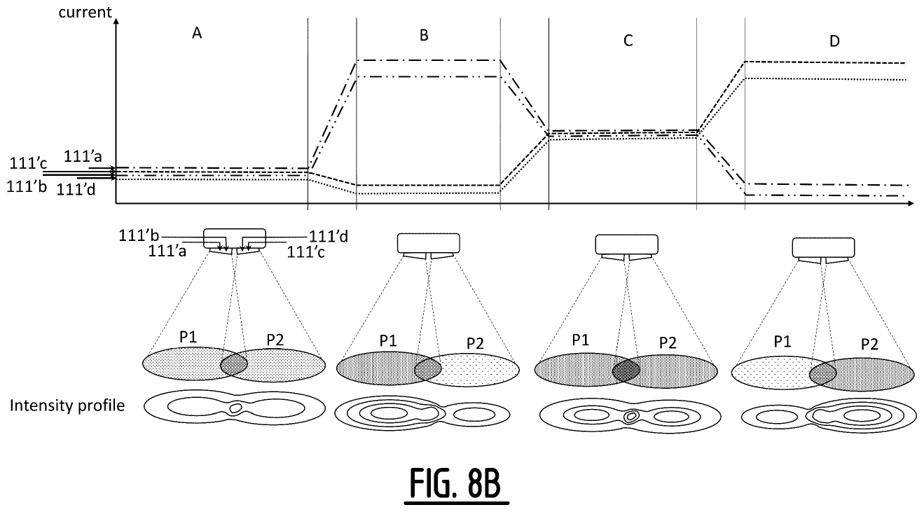

FIG. 7 illustrates a light module with four sets 130a, 130b, 130c, 130d of light emitting elements. The LEDs of each set are connected in series. A first set 130a comprises warm white LEDs and a second set 130b comprises cold white LEDs and the arrangement of the warm and cold LEDs may be such that a good mixture of the warm and cold white light is obtained, e.g. using a checkerboard pattern as shown. Similarly, a third set 130c comprises warm white LEDs and a fourth set 130d comprises cold white LEDs and the arrangement of the warm and cold LEDs of the third and fourth set may be such that a good mixture of the warm and cold white light is obtained, e.g. using a checkerboard pattern as shown. The first and second set 130a, 130b may be provided with a first optics, e.g. a first lens plate 131a, and the third and fourth set 130c, 130d may be provided with a second optics, e.g. a second lens plate 131b, which may be different from the first optics.

The control unit may then be configured to transform the light supply signal into two tunable white channel signals 111′a and 111′b associated with the first and second sets 130a, 130b for generating a first light distribution P1 and two further tunable white signals 111′c and 111′d associated with the third and fourth sets 130c, 130d for generating a second light distribution P2, which may be different from the first light distribution P1.

FIGS. 8a and 8b illustrate control profiles in function of time for controlling the light module of FIG. 7. FIG. 8 illustrates tunable white channel signals 111′a and 111′b and two further tunable white channel signals 111′c and 111′d in function of time, and the resulting light output. For reasons of simplicity the second light distribution P2 is shown to have the same shape as the first light distribution P1 but this shape may also be different. The illustrated channel signals may be obtained based on e.g. a color profile, and intensity profile and a light distribution profile:

| | A | B | C | D |
|---|---|---|---|---|
| color | warm | cold | warm | warm |
| intensity | L1 | L1 | L2 = L1/2 | L1 |
| Light distribution | P1 | P1 | P2 | P1 + P2 |

In a time range A, the desired configuration of the light output may be according to column A of the above-mentioned table, i.e. a warm white color, a high intensity L1 and a light distribution according to P1. In order to obtain a light distribution profile according to P1, only the first and second sets 130a, 130b are lit, i.e. the current in the third and fourth sets 130c, 130d is 0. In order to obtain a warm white color, the current delivered to the first set 130a, comprising warm white LEDs is larger than the current delivered to the second set 130b, comprising cold white LEDs. The arrangement of the warm and cold LEDs output is then such that light output obtained from the mixture of the warm and cold white light is warm.

In a time range B, the desired configuration of the light output may be according to column B of the above-mentioned table, i.e. a cold white color, a high intensity L1 and a light distribution according to P1. Contrary to previous case, in order to obtain a cold white color, the current delivered to the first set 130a, comprising warm white LEDs is smaller than the current delivered to the second set 130b, comprising cold white LEDs. The arrangement of the warm and cold LEDs output is then such that light output obtained from the mixture of the warm and cold white light is cold.

In a time range C, the desired configuration of the light output may be according to column C of the above-mentioned table, i.e. a warm white color, a low intensity L2 (with L2=L1/2) and a light distribution according to P2. Contrary to case A, in order to obtain a light distribution profile according to P2, only the third and fourth sets 130c, 130d are lit, i.e. the current in the first and second sets 130ab is 0. Additionally, in order to obtain a lower intensity L2<L1, the current delivered to the third and fourth sets 130c, 130d is smaller than in time range A. Finally, similarly to time range A, in order to obtain a warm white color, the current delivered to the third set 130c, comprising warm white LEDs is larger than the current delivered to the fourth set 130d, comprising cold white LEDs.

Finally, in a time range D, the desired configuration of the light output may be according to column D of the above-mentioned table, i.e. a warm white color, a high intensity L1 and a light distribution according to a combination of P1 and P2. In order to obtain a light distribution profile according to a combination of P1 and P2, both the first and second sets 130ab and third and fourth sets 130cd are lit, i.e. there is a current delivered to the first and second sets 130ab and to the third and fourth sets 130cd. In the example of a distribution in which the lighting power is equally divided between the P1 and P2 distribution, the currents delivered to the first and second sets 111′a 111′b and to the third and fourth sets 111′c 111′d may be distributed equally between the 130ab and 130cd sets. In the embodiment of the figure, the currents 111′a and 111′c are the same and the currents 111′b and 111′d are the same. Similarly to time range A, in order to obtain a warm white color, the current delivered to the first and third sets 111′a and 111′c, comprising warm white LEDs is larger than the current delivered to the second and fourth sets 111′b and 111′d, comprising cold white LEDs.

FIG. 8b illustrates tunable white channel signals 111′a and 111′b and two further tunable white channel signals 111′c and 111′d in function of time similar to those of FIG. 8a, their resulting light output and how these signals may be configured such as the light output may be used to illuminate objects whose movement is tracked, e.g. a pedestrian crossing a road at a zebra crossing.

In a time range A, the desired intensity for the light output may be low, e.g. a luminaire located next to a zebra crossing at night. In order to illuminate with a light distribution that is a combination of P1 and P2, all signals, both the first and second sets 130ab and third and fourth sets 130cd are delivered with a current. In the embodiment of the figure, all currents 111′a, b, c, d are very similar.

In a time range B, the desired intensity for the light output may be high and the desired distribution may be according to P1, e.g. a person is present on one side of the road corresponding to zone illuminated by P1. In order to obtain a light distribution profile mainly according to P1, the currents delivered to the first and second sets 130ab are much larger than those delivered to the third and fourth sets 130cd.

In a time range C, the desired intensity for the light output may still be high but the desired distribution may be according to a combination of P1 and P2, e.g. the person at the crossing has advanced and is in the middle of the zebra crossing. In order to obtain such a light distribution, both the first and second sets 130ab and third and fourth sets 130cd are delivered with a similar current. In the embodiment of the figure, all currents 111′a, b, c, d are very similar. Because the desired intensity is higher than for the time range A, these currents are higher than those of the time range A.

Finally, in a time range D, the desired intensity for the light output is still high but the desired distribution may be according to P2, e.g. the person at the crossing has advanced to the other side of the road, in a zone corresponding to P2. In order to obtain a light distribution profile mainly according to P2, the currents delivered to the third and fourth sets 130cd are much larger than those delivered to the first and second sets 130ab.

As illustrated from the embodiment described in FIG. 8b, the light output may hence be used to illuminate objects whose movement is tracked, for example by the sensors described in previous figures. It should be noted that although not discussed in this figure, the light color may also be controlled, like in FIG. 8a.

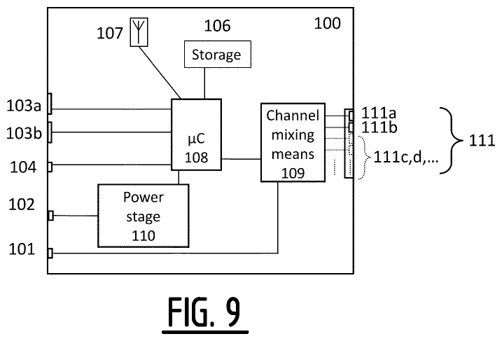

FIG. 9 illustrates schematically an exemplary embodiment of a control unit 100 and its internal components. In addition to the communication port 103 (here comprising two separate ports 103a and 103b), the input port 101, the output ports 111, the supply input port 102, the one or more auxiliary ports 104, the storage means 106 and the antenna 107 already described above, the control unit 100 may comprise a microcontroller 108, a power stage 110 and a channel mixing means 109. The microcontroller 108 is configured to control the channel mixing means 109 based on the signals received at the communication port 103, e.g. using a DALI2 protocol or a UART protocol, and/or at the at least one auxiliary port 104, and/or based on control instructions stored in the storage means 106. The signals received at the at least one auxiliary port 104 may be analog or digital signals. The antenna 107, e.g. an NFC antenna, may be used to wirelessly receive control instructions to be stored in the storage means 106. The channel mixing means 109 is configured to transform the supply input signal received at the input port 101 into the at least two light supply output signals, as controlled by the microcontroller 108, and to deliver the at least two light supply output signals to the at least two output ports 111. The power stage 110 is configured to power the microcontroller 108 and any other components of the control unit 100 which need powering based on a power source signal, typically a DC power supply, e.g. 24V DC, received at the supply input port 102.

The one or more sensors mentioned in the embodiments above may be selected from: an optical sensor such as a photodetector or an image sensor, a sound sensor, a radar such as a Doppler effect radar, a LIDAR, a humidity sensor, a pollution sensor, a temperature sensor, a motion sensor, an antenna, an RF sensor, a vibration sensor, a metering device (e.g. a metering device for measuring the power consumption of a component of an edge device, more in particular a metering device for measuring the power consumption of a driver of a luminaire), a malfunctioning sensor (e.g. a sensor for detecting the malfunctioning of a component of an edge device such as a current leakage detector for measuring current leaks in a driver of a luminaire), a measurement device for measuring a maintenance related parameter of a component of the edge device, an alarm device (e.g. a push button which a user can push in the event of an alarming situation).

Whilst the principles of the invention have been set out above in connection with specific embodiments, it is to be understood that this description is merely made by way of example and not as a limitation of the scope of protection which is determined by the appended claims.

1. A control unit for a light system, said control unit being configured for being electrically connected between a driver and at least two sets of one or more light emitting elements, said driver being configured to drive a set of said at least two sets, said control unit being provided with:
a communication port configured to receive an input control signal and/or to emit an output control signal;
an input port configured to receive a light supply signal from the driver, to power the at least two sets; and
at least two output ports configured to be connected to the at least two sets;
wherein the control unit is configured to transform the light supply signal into at least two light supply output signals based on the input control signal and/or based on stored control instructions, said at least two light supply output signals being delivered to the at least two output ports.

2. The control unit of claim 1, wherein the control unit is further provided with a supply input port configured to receive power for powering the control unit, wherein preferably the supply input port is configured to receive power, preferably a DC voltage, from the driver.

3. (canceled)

4. The control unit of claim 1, wherein the at least two output ports comprise at least three output ports, preferably at least four output ports, wherein preferably the control unit is configured to transform the light supply signal into three or four light supply output signals based on the input control signal for forming an RGB multi-channel signal or an RGBW multi-channel signal, respectively, said three or four light output signals being delivered to the three or four output ports.

5. The control unit of claim 1, wherein the control unit is configured to transform the light supply signal into at least two tunable white channel signals based on the input control signal.

6. The control unit of claim 1, wherein the control unit is configured to transform the light supply signal into two tunable white channel signals associated with two sets of one or more light emitting elements for generating a first light distribution and two further tunable white channel signals associated with two further sets of one or more light emitting elements for generating a second light distribution different from the first light distribution, wherein preferably the control unit is configured to adjust the power of two tunable white channel signals relative to the power of the two further tunable white channel signals to adjust a combined light distribution of the four sets comprising the two sets and the two further sets.

7-8. (canceled)

9. The control unit of claim 1, wherein the control unit is configured to communicate through the communication port using any one or more of the following protocols: I²C, UART, DALI, e.g. DALI2, or 0-10V.

10. The control unit of claim 1:
wherein the input port is configured to receive a light supply signal in the form of a single-channel LED signal, preferably an electric current, from the driver which is preferably a constant current driver, optionally a dimmable constant current driver; and/or
wherein the control unit is configured to deliver on the at least two output ports a multi-channel LED signal, preferably in the form of at least two electric currents.

11. (canceled)

12. The light system of claim 1, wherein the stored control instructions define how to transform the light supply signal into the at least two light supply output signals based on the input control signal and/or wherein the stored control instructions comprise one or more of: a dimming profile defining a dimming level in function of at least one parameter, such as time and/or a sensed value and/or a color value and/or the input control signal; a color profile defining a color in function of at least one parameter, such as time and/or a sensed value and/or the input control signal; a light distribution profile defining a light distribution parameter in function of at least one parameter, such as time and/or a sensed value and/or a color value and/or the input control signal.

13. A control unit for a light system, said control unit being configured for being electrically connected between a driver and at least two sets of one or more light emitting elements, said driver being configured to drive a set of said at least two sets, said control unit being provided with:
a communication port configured to receive an input control signal and to emit an output control signal;
an input port configured to receive a light supply signal from the driver, to power the at least two sets; and
at least two output ports configured to be connected to the at least two sets;
wherein the control unit is configured to transform the light supply signal into at least two light supply output signals, said at least two light supply output signals being delivered to the at least two output ports;
wherein the control unit is configured to generate an output control signal for the driver based on the received input control signal and/or on the stored control instructions and to emit said output control signal through the communication port to the driver.

14. The control unit of claim 1, wherein the control unit is further provided with at least one auxiliary port configured to receive at least one auxiliary signal, such as an analog signal or a digital signal, for example a signal of a sensor, wherein the control unit is configured to transform the light supply signal into the at least two light supply output signals further based on the at least one auxiliary signal.

15. The control unit of claim 1, wherein the input control signal and/or the output control signal is a synchronization signal for synchronizing the control unit with the driver; and/or wherein the control unit is provided with an antenna configured to receive the stored control instructions wirelessly.

16. (canceled)

17. A control unit for a light system, said control unit being configured for being electrically connected between a driver and at least one set of one or more light emitting elements and at least one further component, said control unit being provided with;
a communication port configured to receive an input control signal and/or to emit an output control signal;
an input port configured to receive at least one supply signal from the driver to power the at least one set and the at least one further component; and
at least two output ports configured to be connected to the at least one set and the at least one further component;
wherein the control unit is configured to transform the at least one supply signal into at least two supply output signals based on the input control signal and/or based on stored control instructions, said at least two supply output signals being delivered to the at least two output ports.

18. The control unit of claim 17, wherein the component is an actuator, for example an actuator to control a position of an optical element relative to one or more lighting elements of the at least one set of one or more lighting elements or an actuator to control a position of a sensor of the light system.

19. (canceled)

20. A light system comprising a control unit of claim 1, and at least one set of one or more light emitting elements, preferably at least two sets of one or more light emitting elements; wherein each set of said one or more sets is connected to an output port of the at least two output ports of the control unit, preferably further comprising one or more optical elements for each set of one or more light emitting elements.

21. (canceled)

22. The light system of claim 20, further comprising the driver, wherein the driver is provided with an output port connected to the input port of the control unit and configured to deliver the light supply signal to the control unit, wherein preferably the driver is further provided with a communication port connected to the communication port of the control unit.

23. (canceled)

24. The light system of claim 22, comprising a control unit according to claim 13; wherein the communication port of the driver is configured to receive the output control signal of the control unit; wherein the driver is configured to generate the light supply signal based on the output control signal, wherein optionally the output control signal comprises a dimming control signal, and wherein optionally the driver is configured to determine an amplitude and/or a duty cycle and/or a frequency of the light supply signal in function of the dimming control signal.

25. (canceled)

26. The light system of claim 22, wherein the input control signal comprises a dimming control signal and/or a color control signal and/or a light distribution control signal, and wherein the control unit is configured to determine the output control signal in function of the dimming control signal and/or a color control signal and/or a light distribution control signal.

27. The light system of claim 22, wherein the driver is provided with:
at least one auxiliary control port configured to receive at least one auxiliary control signal, such as an analog or a digital signal;
wherein the driver is configured to generate the light supply signal based on the at least auxiliary control signal, wherein preferably the communication port of the driver is configured to deliver the input control signal to the communication port of the control unit; wherein preferably the driver is configured to generate the input control signal based on the at least one auxiliary control signal; wherein optionally the at least one auxiliary control signal comprises a dimming control signal, and wherein optionally the driver is configured to determine an amplitude and/or a duty cycle and/or a frequency of the light supply signal in function of the dimming control signal.

28-29. (canceled)

30. The light system of claim 22, wherein the driver comprises a storage means storing a dimming profile, and wherein the driver is configured to generate the light supply signal based on the dimming profile; and/or further comprising at least one further component, such as an actuator, connected to an output port of the at least two output ports of the control unit; and/or and wherein the driver is provided with an auxiliary supply output port and configured to generate a supply signal, preferably a DC voltage on said auxiliary supply output port, said auxiliary supply output port being electrically connected to a supply input port of the control unit.

31-33. (canceled)

34. The light system of claim 22, wherein the light system comprises a pole and a luminaire head attached to the pole and the at least one set of one or more lighting elements is arranged in the luminaire head; or wherein the light system comprises multiple pole modules and the at least one set of one or more lighting elements is arranged in a pole module of said multiple pole modules; wherein preferably the control unit is arranged in or on the luminaire head or in or on a pole module; and/or wherein the driver is arranged in or on the luminaire head or in or on a pole module.

35. (canceled)
